(19) United States
(12) Patent Application Publication
(10) Pub. No.: US 2025/0304149 A1
(43) Pub. Date: Oct. 2, 2025

(54) ELECTRONIC CONTROLLER FOR VEHICLE, AND METHOD THEREOF

(71) Applicant: HL MANDO CORPORATION, Pyeongtaek-si (KR)

(72) Inventor: Hyunho HA, Pyeongtaek-si (KR)

(73) Assignee: HL MANDO CORPORATION, Pyeongtaek-si (KR)

(21) Appl. No.: 18/945,161

(22) Filed: Nov. 12, 2024

(30) Foreign Application Priority Data
Mar. 26, 2024 (KR) 10-2024-0040838

(51) Int. Cl. B62D 5/04; G07C 5/08

(52) U.S. Cl. CPC B62D 5/0484; G07C 5/0808

(57) ABSTRACT

Disclosed herein are an electronic controller for a vehicle and a method thereof that can determine control authority of electronic control units (ECUs) according to a failure level. The electronic controller has a first ECU and a second ECU that form a redundant structure in which the first ECU and the second ECU are configured to perform the same function. The electronic controller, in response to diagnosis of a failure of the first ECU and a failure of the second ECU, determines which ECU, among the first ECU and the second ECU, would perform a vehicle control, based on a failure level of the first ECU and a failure level of the second ECU. There is an effect of being able to secure user safety by allowing minimum control even when all ECUs forming the redundant structure fail.

### CROSS-REFERENCE TO RELATED APPLICATION

This application claims priority to and the benefit of Korean Patent Application No. 10-2024-0040838, filed on Mar. 26, 2024, the disclosure of which is incorporated herein by reference in its entirety.

### BACKGROUND

### 1. Field

The present disclosure relates to a vehicle control technology, and more particularly, to a technology for preparing for a failure of an electronic controller of a vehicle including two or more electronic control units (ECUs).

### 2. Discussion of Related Art

As the proportion of electronic equipment in vehicles continues to increase, the role and importance of electronic control units (ECUs) are also increasing.

In the case of the traditional vehicle steering system, since a steering device and wheels are directly connected, when a user operates the steering device (steering wheel), force is transmitted to the wheels using a method in which a hydraulic or electric motor assists the force. The hydraulic or electric motor is a device that assists the user's force, and thus, the hydraulic or electric motor only serves to allow the user to easily operate the steering device. Accordingly, even when an auxiliary device of the hydraulic or electric motor fails, the user can still control the wheels to some extent by operating the steering device through his or her own force, and thus, it is possible to respond even in an emergency situation.

However, in the related steer-by-wire (SBW) technology, a steering device and wheels are not directly connected, each of the steering device and the wheels are connected to one of actuators, and these actuators are connected to each other through electrical signals. Therefore, when the actuator connected to the steering device (steering feedback actuator (SFA)) or the actuator connected to the wheel (road wheel actuator (RWA)) fails, steering may become impossible in the worst case.

In order to respond to such a situation, measures such as installing a plurality of ECUs are taken, but the problem is that even these become useless in a situation in which all of the plurality of ECUs fail.

Research efforts have been made to solve the failure occurrence problem of the plurality of ECUs according to the related art, and after much efforts, the present disclosure provides a vehicle electronic controller and method capable of preventing loss of control of a vehicle by classifying ECU failures into grades and enabling minimum control by the ECU with no fatal failure.

### SUMMARY

The present disclosure relates to providing an electronic controller for a vehicle, having a redundant structure, which enables minimum control even when all of a plurality of electronic control units (ECUs) fail.

The present disclosure is also directed to providing an electronic controller and a method thereof that can more delicately respond to failures by setting individual failure severity and whether a basic operation is possible for each ECU.

Meanwhile, other unspecified objects of the present disclosure will be additionally considered within the scope that can be easily inferred from the following detailed description and an effect thereof.

According to an aspect of the present disclosure, there is provided an electronic controller for a vehicle, which includes a memory in which one or more instructions are stored, and a first ECU and a second ECU configured to execute the one or more instructions stored in the memory, wherein the first ECU and the second ECU form a redundant structure in which the first ECU and the second ECU are configured to perform the same function, and wherein the electronic controller, in response to diagnosis of a failure of the first ECU and a failure of the second ECU, determines which ECU, among the first ECU and the second ECU, is set to perform a vehicle control, based on a failure level of the first ECU and a failure level of the second ECU.

The first ECU and the second ECU may form a redundant structure for performing steer-by-wire (SBW) control.

The electronic controller may further include a third ECU configured to diagnose whether the first ECU and the second ECU fail.

The failure level may include a first failure level which is a failure level at which no functions are operable, and a second failure level which is a failure level at which some functions are operable.

When both the first ECU and the second ECU fail, the ECU at the second failure level may perform the vehicle control.

When a failure of the first ECU is detected, when a failure of the second ECU is not detected (i.e., the second ECU is in a normal state), the first ECU may transfer control authority to the second ECU, and when a failure of the second ECU is detected, the control authority may be determined by comparing the failure levels of the first ECU and the second ECU.

After the second ECU has taken over the control authority by the diagnosis of the normal state of the second ECU, when a failure of the second ECU is then detected, when a failure level of the second ECU is at the first failure level, and the failure level of the first ECU is at the second failure level, the control authority may be transferred back to the first ECU; and when the failure level of the second ECU is the second failure level and the failure level of the first ECU is the second failure level or the first failure level, the second ECU may maintain the control authority.

According to another aspect of the present disclosure, there is provided a vehicle control method performed by an electronic controller for a vehicle, which includes two or more electronic control units (ECUs), which form a redundant structure, and a memory, the vehicle control method including diagnosing whether a first ECU of the electronic controller is in a failure, after the failure of the first ECU is diagnosed, diagnosing whether a second ECU of the electronic controller is in a failure, and in response to diagnosis of the failure of the first ECU and the failure of the second ECU, determining which ECU, among the first ECU and the second ECU, is set to perform a vehicle control, based on a failure level of the first ECU and a failure level of the second ECU.

The diagnosing of the failures of the first ECU and the second ECU may be performed by a third ECU of the electronic controller.

The determining of the ECU for performing vehicle control according to a failure level when the second ECU fails may include determining one ECU having the second failure level, among the first ECU and the second ECU, to perform the vehicle control.

In response to the diagnosis of the failure of the first ECU and the diagnosis of a normal state of the second ECU, the method may further include transferring control authority to the second ECU from the first ECU.

The vehicle control method may further include, after the transferring of the control authority to the second ECU from the first ECU, in response to the diagnosis of the failure of the second ECU, transferring back the control authority to the first ECU when the failure level of the second ECU is at the first failure level and the failure level of the first ECU is at the second failure level.

The vehicle control method may further include, after the second ECU has taken over the control authority from the first ECU, in response to the diagnosis of the failure of the second ECU, maintaining the control authority at the second ECU when the failure level of the second ECU is at the second failure level and the failure level of the first ECU is at the second failure level or the first failure level.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic structural diagram illustrating an electronic controller for a vehicle according to an exemplary embodiment of the present disclosure;

FIG. 2 is a schematic structural diagram illustrating a steering system including the electronic controller for a vehicle according to the exemplary embodiment of the present disclosure;

FIGS. 3 to 6 are control flowcharts of an electronic control unit (ECU) included in the electronic controller for a vehicle according to the exemplary embodiment of the present disclosure;

FIG. 7 is a schematic flowchart illustrating a vehicle control method according to another exemplary embodiment of the present disclosure; and

FIG. 8 is a schematic flowchart illustrating a vehicle control method according to the conventional art.

It is noted that the accompanying drawings are illustrated as references for understanding the technical spirit of the present disclosure, and thereby the scope of the present disclosure is not limited thereto.

### DETAILED DESCRIPTION

The above object and means of the present disclosure and their effects will become more apparent through the following detailed description in relation to the accompanying drawings, and accordingly, those of ordinary skill in the art to which the present disclosure pertains can easily implement the technical idea of the present disclosure. In addition, in the following description of the present disclosure, when a detailed description of the known related art is determined to obscure the gist of the present disclosure, the detailed description thereof will be omitted.

Terms used herein are for the purpose of describing the embodiments and are not intended to limit the present disclosure. In the present specification, the singular forms include the plural forms unless the context clearly dictates otherwise. In the present specification, the term “include,” “comprise,” “provide,” or “have” does not exclude the presence or addition of one or more components other than the described components.

In the present specification, terms such as “or” and “at least one” may indicate one among words listed together or indicate a combination of two or more. For example, “A or B” and “at least one of A and B” may include only one of A or B or include both A and B.

In the present specification, a description using “for example” or the like should not be construed as limiting the embodiments of the present disclosure by the effect of variations such as tolerances, measurement errors, limitations of measurement accuracy, and other commonly known factors, and the information presented, such as cited characteristics, variables, or values, may not be exactly the same.

In the present specification, when a first component is referred to as being “connected” or “coupled” to a second component, the first component may be directly connected or coupled to the second component, but it should be understood that a third component may be present between the first component and the second component. Conversely, when a first component is referred to as being “directly connected” or “directly coupled” to a second component, it should be understood that a third component may not be present between the first component and the second component.

In the present specification, when a first component is described as being “on” or “in contact with” a second component, it should be understood that the first component may be in direct contact with or connected to the second component, but there may also be a third component present therebetween. On the other hand, when a first component is described as being “directly on” or “in direct contact with” a second component, it may be understood that no other component is present between the first component and the second component. Other expressions that describe relationships between components, such as “between” and “directly between,” can also be construed similarly.

In the present specification, the terms “first,” “second,” and the like may be used to describe various components, but the components should not be limited by these terms. In addition, the terms should not be construed to limit the order of the components and may be used to distinguish one component from another component. For example, a first component may be referred to as a second component, and similarly, a second component may also be referred to as a first component.

Unless defined otherwise, all terms used herein may be used in a sense commonly understood by those skilled in the art to which the present disclosure pertains. In addition, terms defined in a commonly used dictionary are not to be construed ideally or excessively unless specifically defined explicitly.

Hereinafter, exemplary embodiments of the present disclosure will be described in detail with reference to the accompanying drawings.

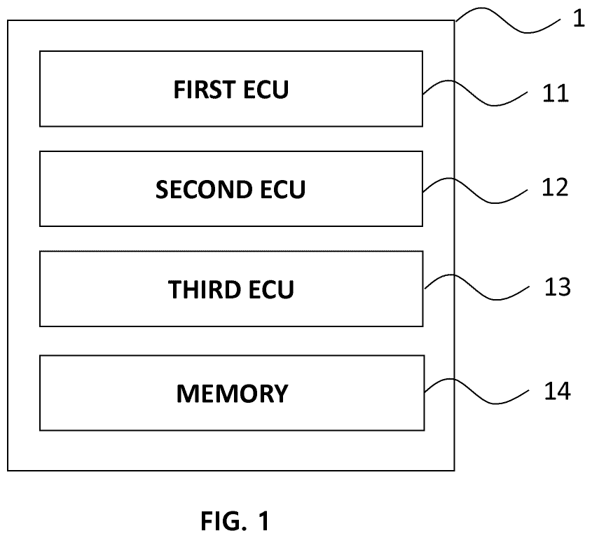

FIG. 1 is a schematic structural diagram illustrating an electronic controller for a vehicle according to an exemplary embodiment of the present disclosure.

An electronic controller 1 for a vehicle according to the present disclosure may include two or more electronic control units (ECUs) and one or more memories 14. For example, the electronic controller 1 for a vehicle according to the present disclosure may include a first ECU 11, a second ECU 12, and the memory 14.

The electronic controller 1 for a vehicle is used to control various electronic devices of a vehicle. Hereinafter, a steer-by-wire (SBW) device, which is a steering device of a vehicle, will be described as an example, and it is of course true that the present disclosure can be applied to any ECU with a redundant structure.

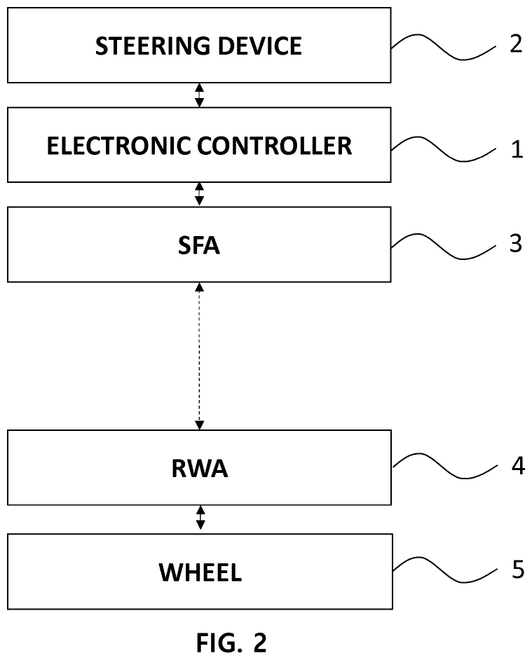

FIG. 2 is a schematic structural diagram illustrating the SBW device controlled by the electronic controller 1 according to the present disclosure.

In the SBW device, a steering device 2 and a wheel 5 are not physically connected and are only electrically connected through wires. Therefore, when a user operates the steering device 2 such as a steering wheel, the electronic controller 1 generates an electric signal corresponding to the operation and transmits the electric signal to a second actuator 4 connected to the wheel 5, and controls a direction of the wheel 5 with the second actuator 4.

Feedback from the wheel 5 is also transmitted as an electrical signal to the first actuator 3 connected to the steering device 2, and the electronic controller 1 transmits the feedback signal to the steering device 2 with the first actuator 3.

The first ECU 11 and the second ECU 12 may each include one or more processors and one or more memories. Alternatively, the first ECU 11 and the second ECU 12 may share one common memory 14.

The memory 14 may store instructions, data structures, and program codes that can be read by the processors included in the first ECU 11 and the second ECU 12. In embodiments, at least operations performed by the processors may be implemented by executing instructions or codes of a program stored in the memory 14.

The memory 14 may include a flash type memory, a hard disk type memory, a multimedia card micro type memory, or a card type memory (e.g., a secure digital (SD) or extreme digital (XD) memory) and may include a non-volatile memory including at least one among a read only memory (ROM), an electrically erasable programmable read only memory (EEPROM), a programmable read only memory (PROM), a magnetic memory, a magnetic disk, and an optical disc, and a volatile memory such as a random access memory (RAM) and a static random access memory (SRAM).

The memory 14 may store one or more instructions or programs that the electronic controller 1 for a vehicle may use to control the vehicle.

The processors included in the first ECU 11 and the second ECU 12 control the overall operations of the electronic controller 1 for a vehicle. For example, the processor may control the overall operation of the electronic controller 1 for a vehicle for controlling the vehicle by executing one or more instructions stored in the memory 14.

The processor may be formed of at least one of, for example, central processing units, microprocessors, graphics processing units, application specific integrated circuits (ASICs), digital signal processors (DSPs), digital signal processing devices (DSPDs), programmable logic devices (PLDs), field programmable gate arrays (FPGAs), application processors, neural processing units, and artificial intelligence (AI)-specific processors designed in a hardware structure specialized for processing AI models, but the present disclosure is not limited thereto.

Due to the structural features of such an SBW device, the electronic controller 1 for a vehicle according to the present disclosure may include a first ECU 11 and a second ECU 12. In addition, the first ECU 11 and the second ECU 12 are formed in a redundant structure so that each ECU may control all functions of the SBW device.

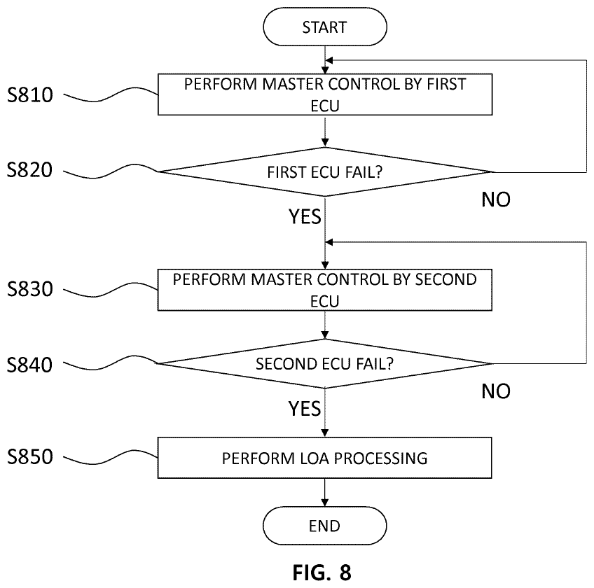

FIG. 8 shows an example of a method of controlling electronic equipment included in the vehicle with the first ECU 11 and the second ECU 12 in the redundant structure.

Since the first ECU 11 and the second ECU 12 may each perform 100% control on the electronic equipment included in the vehicle, the first ECU 11 may operate as a master and the second ECU 12 may operate as a slave under normal circumstances.

For example, the first ECU 11 may act as the master and control 100% of the electronic equipment, or the first ECU 11 may control most of the electronic equipment while the second ECU 12 assists the first ECU 11.

The first ECU 11 performs main control on the electronic equipment of the vehicle (S810), determines whether there is a failure in the first ECU 11 (S820), and when no failure is detected, performs the main control continuously.

However, when a failure of the first ECU 11 is diagnosed detected as a result of the failure diagnosis, the first ECU 11 transfers control authority to the second ECU 2 regardless of the type of failure.

The second ECU 12, which takes over the control authority, performs the main control (S830).

During the main control by The second ECU 12, it is determined whether a failure occurs in the second ECU 12 (S840), and when a failure is diagnosed, both ECUs fail, and thus loss of assistance (LOA) processing is performed.

However, when the LOA processing is performed without distinguishing a failure level as described above, even when the first ECU 11 or the second ECU 12 may perform some functions, it may lead to a dangerous situation in which the first ECU 11 or the second ECU 12 cannot perform any functions due to the LOA processing. Therefore, an objective of the present disclosure is to prevent a dangerous situation by classifying failures by level and adjusting the control authority of the ECU appropriately according to the classified failure level.

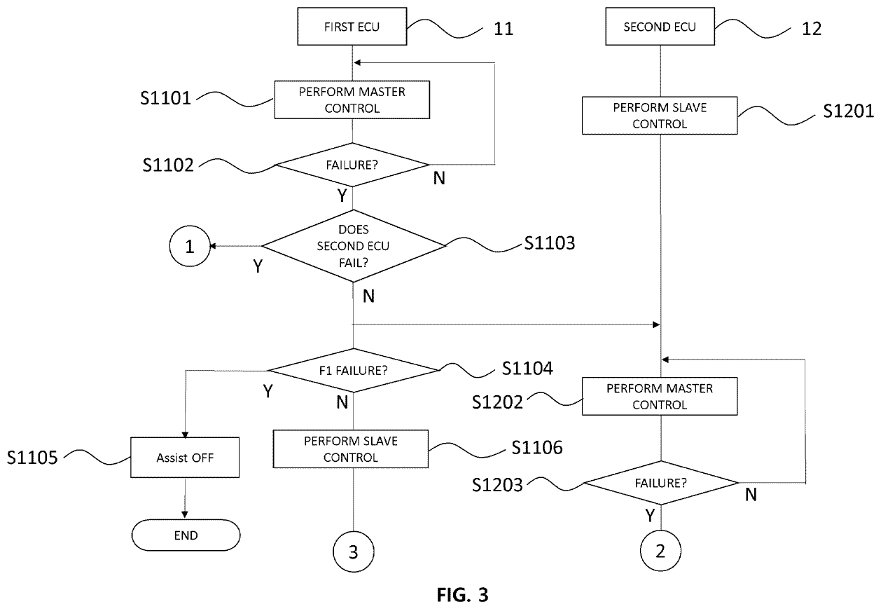

FIGS. 3 to 6 are schematic control flowcharts of the electronic controller 1 included in the electronic controller for a vehicle according to the exemplary embodiment of the present disclosure.

In FIG. 3, in a situation in which both the first ECU 11 and the second ECU 12 are operating normally, the first ECU 11 performs master control (S1101) and the second ECU 12 performs slave control (S1201).

While the first ECU 11 performs the master control, it is determined whether a failure occurs in the first ECU 11 (S1102), and when no failure occurs (i.e., normal state), the first ECU performs the master control continuously (S1101).

On the other hand, when a failure occurs in the first ECU 11, it is determined whether a failure also occurs in the second ECU 12 (S1103).

In the present embodiment, it is described that the first ECU 11 and the second ECU 12 diagnose their own failures. However, when the first ECU 11 or the second ECU 12 has a failure that renders it unable to operate at all, it cannot diagnose its own failure. Therefore, a third ECU may be present separately to diagnose the failures of the first and second ECUs 11 and 12.

To this end, the electronic controller 1 for a vehicle of the present disclosure may further include a third ECU 13. The third ECU 13 may diagnose failures of the first ECU 11 and the second ECU 12 and set flags regarding the type and severity of a failure, such as a first failure level F1 and a second failure level F2, for each ECU. In addition, the third ECU 13 may control which ECU is set with master control authority or slave control authority according to a failure level.

When no failure occurs in the second ECU 12 (i.e., normal state of the second ECU 12), the first ECU 11 transfers the master control authority to the second ECU 12, and the second ECU 12 takes over the master control authority and performs the master control (S1202).

After the first ECU 11 transfers the master control authority to the second ECU 12, the failure level of the first ECU 11 is diagnosed (S1104).

When the failure level of the first ECU 11 is a first failure level F1, since the first ECU 11 cannot perform any operation at all, a control assistance function is turned off (Assist OFF in S1105) and the operation is terminated.

When the failure level of the first ECU 11 is a second failure level F2, since the first ECU 11 cannot perform full control functions but may perform some control functions, the first ECU 11 performs slave control by assisting the second ECU 12 performing the master control (S1106). In this way, the electronic controller 1 for a vehicle according to the present disclosure has a feature of adjusting the control authority between the ECUs by classifying ECU failures by level.

An error corresponding to the first failure level is an error that has a critical impact on the system operation and is a failure level that requires power supply to the motor to be cut off.

Examples of errors corresponding to the first failure level include Motor Sensor Power supply Error, MotAg Error, CurrentSensor error, GateDriver Error, Motor Phase Error, Motor Current error, Regulator Error, BattU-BrdgU Voltage Diff Error, Wdg, ISnsr error, and Regulator Spi Error.

Errors corresponding to the second failure level may have a fatal effect on the system operation, but are not related to a motor operation, and thus it is a failure level at which a certain degree of limited operation is possible.

Examples of errors corresponding to the second failure level include Torque sensor Voltage out of range, SteerWhlTq1-2 Sig Comp error, Torque Sensor Invalid, RackAngle Power Supply Error, Pinion Angle, and Angle Sensor Error.

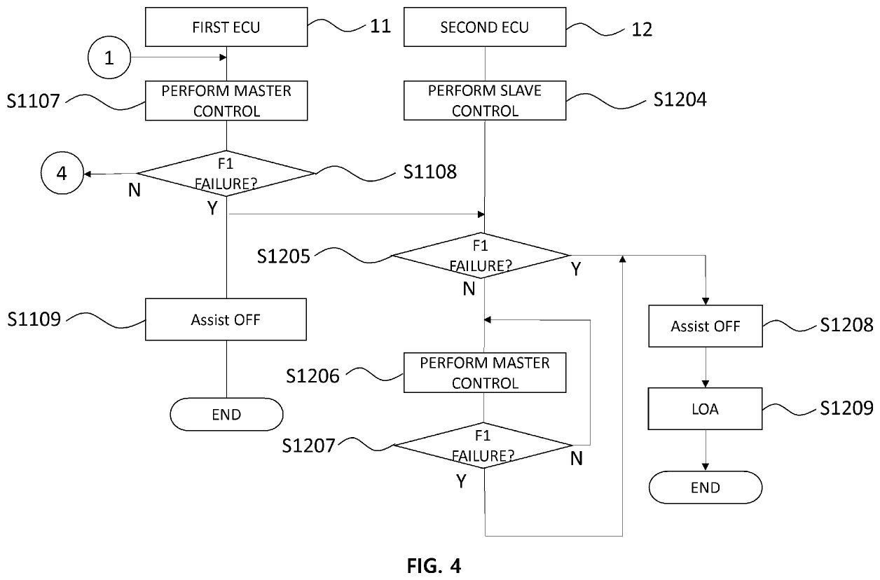

FIG. 4 is a schematic control flowchart of the electronic controller 1 for a vehicle when a failure also occurs in the second ECU 12.

When a failure also occurs in the second ECU 12, the first ECU 11 does not transfer the control authority to the second ECU 12, and thus the first ECU 11 performs the master control (S1107) and the second ECU 12 performs the slave control (S1204).

A failure level of the first ECU 11 is determined (S1108), and when the failure level of the first ECU 11 is the first failure level F1, since control cannot be performed at all, the control assistance function is turned off (Assist OFF in S1105) and the operation of the first ECU 11 is terminated.

A failure level of the second ECU 12 is also determined (S1205), and when the failure level of the second ECU 12 is the first failure level F1, since the second ECU 12 cannot perform control at all, the control assistance function is turned off (S1208), and since neither the first ECU 11 nor the second ECU 12 can operate normally, LOA processing (S1209) is performed and then the control operation of both the first ECU 11 and the second ECU 12 is terminated.

When the failure level of the second ECU 12 is the second failure level F2, the second ECU 12 performs the master control (S1206) instead of the first ECU 11, whose failure level is the first failure level, and performs the master control until a failure at the first failure level occurs (S1207).

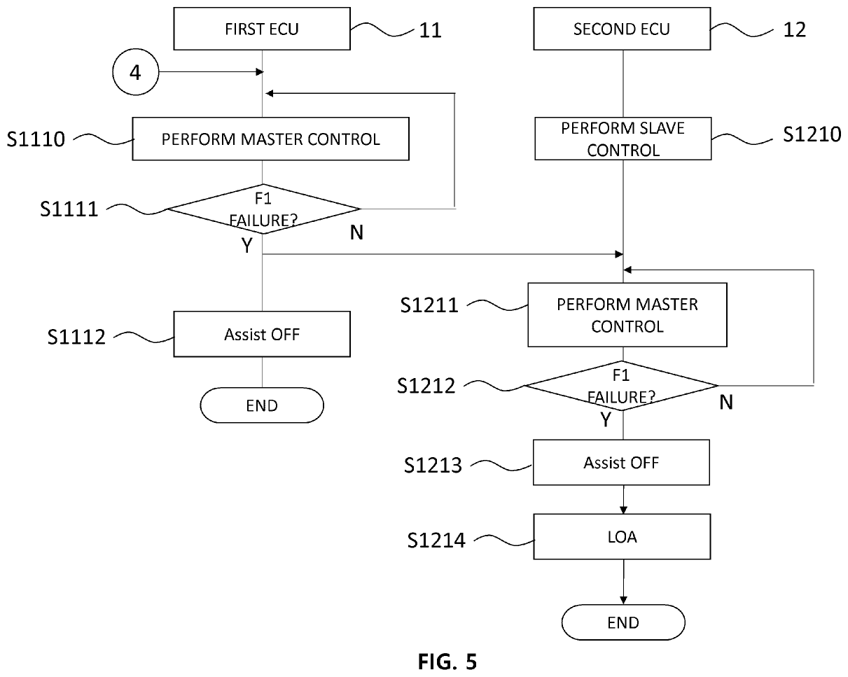

FIG. 5 is a schematic control flowchart of the electronic controller 1 for a vehicle when a failure of the first ECU 11 is at second failure level when a failure also occurs in the second ECU 12.

When a failure also occurs in the second ECU 12, since the first ECU 11 may perform some operations even when a failure at the second failure level occurs, the first ECU 11 continues to perform the master control (S1110), and the second ECU 12 assists the first ECU 11 to perform the slave control (S1210).

When a failure at the first failure level occurs in the first ECU 11 during the operation (S1111), the first ECU 11 transfers the master control authority to the second ECU 12, and turns off the control assistance function (Assist OFF in S1112) to terminate the operation.

The second ECU 12 takes over the control authority from the first ECU 11 and performs the master control (S1211). When the failure at the first failure level also occurs in the second ECU 12 (S1212), since both the first ECU 11 and the second ECU 12 are at the first failure level, the control assistance function is turned off (S1213), LOA processing is performed (S1214), and then the control operation is terminated.

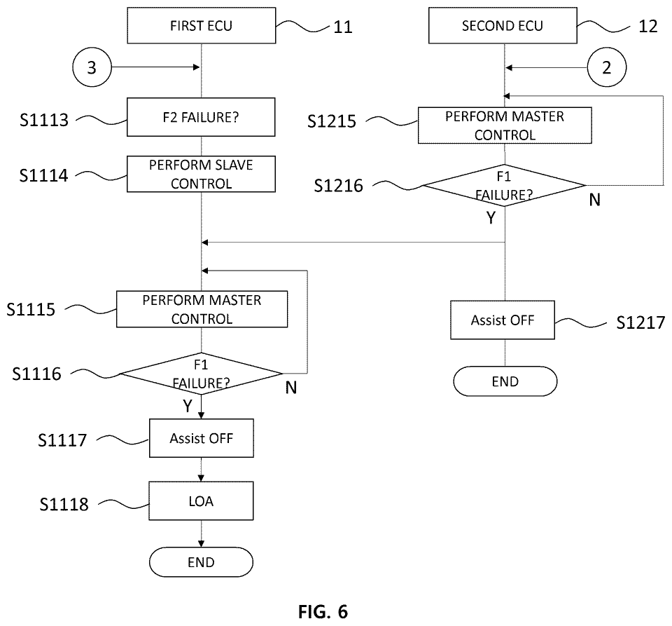

FIG. 6 is a schematic control flowchart of the electronic controller 1 for a vehicle when a failure occurs while the master control is performed because no failure occurs in the second ECU 12.

When a failure at the second failure level occurs in the first ECU 11 (S1113), the first ECU 11 performs the slave control (S1114), and since no failure occurs in the second ECU 12, the second ECU 12 performs the master control (S1215).

During this process, when the failure at the first failure level F1 occurs in the second ECU 12 (S1216), the second ECU 12 transfers the master control authority back to the first ECU 11, turns off a control assistance function (S1217), and terminates the operation.

The first ECU 11, which takes over the master control authority again, performs the master control (S1115), and when the failure at the first failure level F1 occurs during performance of the master control (S1116), the control assistance function is turned off (S1117), and since the first ECU 11 and the second ECU 12 are both in a failure state at the first failure level, the LOA processing is performed (S1118).

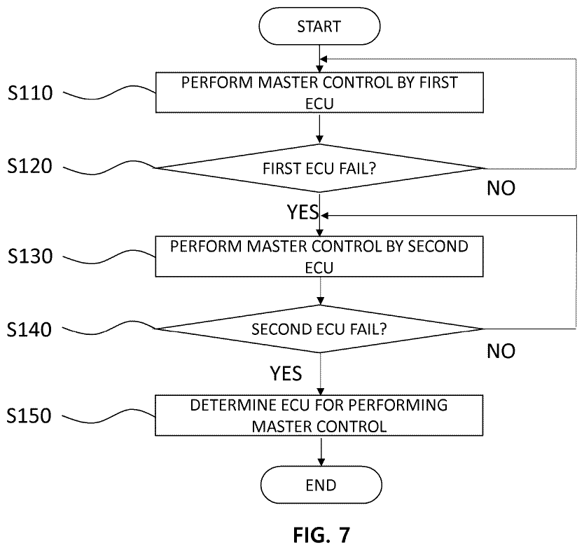

FIG. 7 is a schematic flowchart illustrating a vehicle control method according to another exemplary embodiment of the present disclosure.

The vehicle control method according to the present disclosure may be performed by an electronic controller for a vehicle including one or more processors and memories.

The electronic controller for a vehicle may be formed such that a first ECU and a second ECU form a redundant structure in which the first ECU and the second ECU are configured to perform the same function. Therefore, even when the first ECU or the second ECU fails, the remaining ECU may perform the same vehicle control as in a normal situation.

First, in a situation in which both the first ECU and the second ECU are in a normal state, the first ECU performs master control, and the remaining second ECU performs slave control (S110).

The first ECU continuously diagnosis whether the first ECU fails while performing the master control (S120), and when the first ECU does not fail, the first ECU continues to perform the master control.

When a failure of the first ECU is diagnosed, the first ECU transfers control authority to the second ECU with no failure, and the second ECU with no failure performs the master control (S130).

In this case, when the failure of the first ECU is at the first failure level, the first ECU stops the operation, and when the failure of the first ECU is at the second failure level, the first ECU may assist the second ECU to perform the slave control.

Even while the second ECU is performing the master control, a failure level of the second ECU is continuously determined (S140), and when the second ECU also fails, the failure levels of the two ECUs are compared to determine the ECU to perform the master control (S150).

Depending on the failure level, the ECUs that perform the master control and the slave control are determined. When both the ECUs are at the second failure level F2, one ECU performs the master control and the other ECU performs the slave control.

On the other hand, when both the ECUs are at first failure level F1, since neither of the ECUs can operate normally, the ECUs both turn off the control assistance function (Assist off) and perform LOA processing.

When one ECU is at the second failure level and the other ECU is at the first failure level, the ECU at the second failure level performs the master control, and the ECU at the first failure level turns off the control assistance function and stops the operation.

A more detailed flow of the control is as described above.

In this way, according to the electronic controller for a vehicle and a method thereof according to the present disclosure, by classifying a failure according to its level in ECUs with a redundant structure and controlling an electronic device by an ECU capable of performing some functions, there is an effect of being able to prevent a vehicle from stopping or becoming uncontrollable in an emergency situation.

According to the present disclosure, there is an advantage of being able to control authority more effectively when a plurality of electronic control units (ECUs) with a redundant structure fail.

In addition, even when some functions of the ECU fail, minimum control of a vehicle is possible, and there is an effect of being able to increase user safety.

Meanwhile, it is noted that even effects that are not explicitly described herein but that can be expected from the technical features of the present disclosure and their provisional effects are considered as having been described in the specification of the present disclosure.

Although the specific embodiments have been described in the detailed description of the present disclosure, various modifications are possible without departing from the scope of the present disclosure. Therefore, the scope of the present disclosure is not limited to the described embodiments and should be defined by the appended claims and equivalents thereof.

What is claimed is:

1. An electronic controller for a vehicle, comprising:
a memory in which one or more instructions are stored; and
a first electronic control unit (ECU) and a second ECU,
wherein each of the first ECU and the second ECU is configured to execute the one or more instructions stored in the memory,
wherein the first ECU and the second ECU form a redundant structure in which the first ECU and the second ECU are configured to perform the same function, and
wherein the electronic controller, in response to diagnosis of a failure of the first ECU and a failure of the second ECU, determines which ECU, among the first ECU and the second ECU, is set to perform a vehicle control, based on a failure level of the first ECU and a failure level of the second ECU.

2. The electronic controller of claim 1, wherein the redundant structure of the first ECU and the second ECU is configured to perform steer-by-wire (SBW) control.

3. The electronic controller of claim 1, further comprising a third ECU,
wherein third ECU is configured to diagnose whether the first ECU is in the failure, and diagnose whether the second ECU is in the failure.

4. The electronic controller of claim 1, wherein the failure level includes a first failure level which is a failure level at which no functions are operable, and a second failure level which is a failure level at which some functions are operable.

5. The electronic controller of claim 4, wherein, when both the failure of the first ECU and the failure of the second ECU are diagnosed, one ECU having the second failure level, among the first ECU and the second ECU, performs the vehicle control.

6. The electronic controller of claim 4, wherein:
in response to the diagnosis of the failure of the first ECU and the diagnosis of a normal state of the second ECU, the first ECU transfers control authority to the second ECU; and
in response to the diagnosis of the failure of the first ECU and the failure of the second ECU, the electronic controller determines which ECU, among the first ECU and the second ECU, would have the control authority, by comparing the failure level of the first ECU and the failure level of the second ECU.

7. The electronic controller of claim 6, wherein:
after the second ECU has taken over the control authority from the first ECU, in response to the diagnosis of the failure of the second ECU, the second ECU transfers back the control authority to the first ECU when the failure level of the second ECU is at the first failure level and the failure level of the first ECU is at the second failure level; and
after the second ECU has taken over the control authority from the first ECU, in response to the diagnosis of the failure of the second ECU, the second ECU maintains the control authority when the failure level of the second ECU is at the second failure level and the failure level of the first ECU is at the second failure level or the first failure level.

8. A vehicle control method performed by an electronic controller for a vehicle, which includes two or more electronic control units (ECUs), which form a redundant structure, and a memory, the vehicle control method comprising:
diagnosing whether a first ECU of the electronic controller is in a failure;
after the failure of the first ECU is diagnosed, diagnosing whether a second ECU of the electronic controller is in a failure; and
in response to diagnosis of the failure of the first ECU and the failure of the second ECU, determining which ECU, among the first ECU and the second ECU, is set to perform a vehicle control, based on a failure level of the first ECU and a failure level of the second ECU.

9. The vehicle control method of claim 8, wherein the first ECU and the second ECU form a redundant structure in which the first ECU and the second ECU are configured to perform the same function for steer-by-wire (SBW) control.

10. The vehicle control method of claim 8, wherein the diagnosing of the failure of the first ECU and the diagnosing of the failure of the second ECU are performed by a third ECU of the electronic controller.

11. The vehicle control method of claim 8, wherein the failure level includes a first failure level which is a failure level at which no functions are operable, and a second failure level which is a failure level at which some functions are operable.

12. The vehicle control method of claim 11, wherein the determining comprises:
determining one ECU having the second failure level, among the first ECU and the second ECU, to perform the vehicle control.

13. The vehicle control method of claim 11, further comprising:
in response to the diagnosis of the failure of the first ECU and the diagnosis of a normal state of the second ECU, transferring control authority to the second ECU from the first ECU.

14. The vehicle control method of claim 13, further comprising:
after the transferring of the control authority to the second ECU from the first ECU, in response to the diagnosis of the failure of the second ECU, transferring back the control authority to the first ECU when the failure level of the second ECU is at the first failure level and the failure level of the first ECU is at the second failure level; and
after the second ECU has taken over the control authority from the first ECU, in response to the diagnosis of the failure of the second ECU, maintaining the control authority at the second ECU when the failure level of the second ECU is at the second failure level and the failure level of the first ECU is at the second failure level or the first failure level.
